(19) United States
(12) Patent Application Publication
(10) Pub. No.: US 2026/0066818 A1
(43) Pub. Date: Mar. 5, 2026

(54) MOTOR DRIVE DEVICE

(71) Applicants: KABUSHIKI KAISHA TOSHIBA, Kawasaki-shi (JP); Toshiba Electronic Devices & Storage Corporation, Kawasaki-shi (JP)

(72) Inventors: Takashi Takagi, Kawasaki Kanagawa (JP); Toshimitsu Aizawa, Yokohama Kanagawa (JP); Tadashi Asukai, Yokohama Kanagawa (JP)

(21) Appl. No.: 19/304,930

(22) Filed: Aug. 20, 2025

(30) Foreign Application Priority Data
Aug. 27, 2024 (JP) 2024-145736

(51) Int. Cl. H02P 6/15; H02P 29/024

(52) U.S. Cl. CPC H02P 6/153; H02P 29/0241; H02P 2207/055

(57) ABSTRACT

According to one embodiment, a motor drive device includes: a conversion device converting a DC voltage into a three-phase AC power, and supplying the AC power to a motor; a detection circuit detecting a voltage at a DC side of the conversion device; a control circuit to apply a drive voltage to the motor; phase adjustment circuits adjusting a phase of the drive voltage; and a selection circuit selecting one of calculation results of the phase adjustment circuits and outputting the selected result to the control circuit. A first phase adjustment circuit of the phase adjustment circuits perform control to exert the advancing phase on a phase of the drive voltage if a detection value of the detection circuit exceeds a threshold, and the phase adjustment selection circuit selects an output of the first phase adjustment circuit if the detection value exceeds the threshold.

### CROSS-REFERENCE TO RELATED APPLICATION(S)

This application is based upon and claims the benefit of priority from Japanese Patent Application No. 2024-145736, filed Aug. 27, 2024, the entire contents of which are incorporated herein by reference.

### FIELD

Embodiments described herein relate generally to a motor drive device.

### BACKGROUND

In order to improve the efficiency of motor systems, synchronous motors using permanent magnets have become widespread, and various motor control methods have been proposed.

### BRIEF DESCRIPTION OF THE DRAWINGS

FIG. 1 is a block diagram showing an example of a configuration of a motor drive device according to a first embodiment.

FIG. 2 is a vector diagram showing a current phase relating to the motor drive device according to the first embodiment.

FIG. 3 is a vector diagram showing a current phase relating to the motor drive device according to the first embodiment.

FIG. 4 is a diagram showing a relationship between a phase of the back EMF (electromotive force) in a motor and a phase of a motor current relating to the motor drive device according to the first embodiment.

FIG. 5 is a vector diagram showing a current phase relating to the motor drive device according to the first embodiment.

FIG. 6 is a diagram showing a relationship between an index and phase advancing control relating to the motor drive device according to the first embodiment.

FIG. 7 is a schematic diagram illustrating an influence of regeneration relating to the motor drive device according to the first embodiment.

FIG. 8 is a schematic diagram illustrating regenerative control relating to the motor drive device according to the first embodiment.

FIG. 9 is a flowchart showing an example of operation of the motor drive device according to the first embodiment.

FIG. 10 is a flowchart showing an example of operation of the motor drive device according to the first embodiment.

FIG. 11 is a flowchart showing an example of operation of the motor drive device according to the first embodiment.

FIG. 12 is a block diagram showing an example of a configuration of a motor drive device according to a second embodiment.

FIG. 13 is a waveform diagram of a DC current relating to the motor drive device according to the second embodiment.

FIG. 14 is a flowchart showing an example of operation of the motor drive device according to the second embodiment.

FIG. 15 is a diagram for illustrating a method of evaluating a slope of a motor current relating to the motor drive device according to the second embodiment.

FIG. 16 is a flowchart showing an example of operation of the motor drive device according to the second embodiment.

### DETAILED DESCRIPTION

In general, according to one embodiment, a motor drive device includes: a three-phase synchronous motor; a power conversion device configured to convert a DC voltage into a three-phase AC power of a given voltage and a given frequency through a switching operation of a plurality of semiconductor elements, and supply the three-phase AC power after conversion to the three-phase synchronous motor; a voltage detection circuit configured to detect a voltage at a DC input side of the power conversion device; a voltage control circuit configured to provide an on/off command to the plurality of semiconductor elements in order for the power conversion device to apply a drive voltage of a given voltage and a given frequency to the three-phase synchronous motor; a plurality of phase adjustment circuits each configured to adjust a phase of the drive voltage; and a phase adjustment selection circuit configured to select one of calculation results of the plurality of phase adjustment circuits and output the selected calculation result to the voltage control circuit, wherein a first phase adjustment circuit of the plurality of phase adjustment circuits perform control to exert the advancing phase on a phase of the drive voltage in a case where a voltage detection value obtained from the voltage detection circuit exceeds a first threshold value, and the phase adjustment selection circuit selects an output of the first phase adjustment circuit in a case where the voltage detection value exceeds the first threshold value.

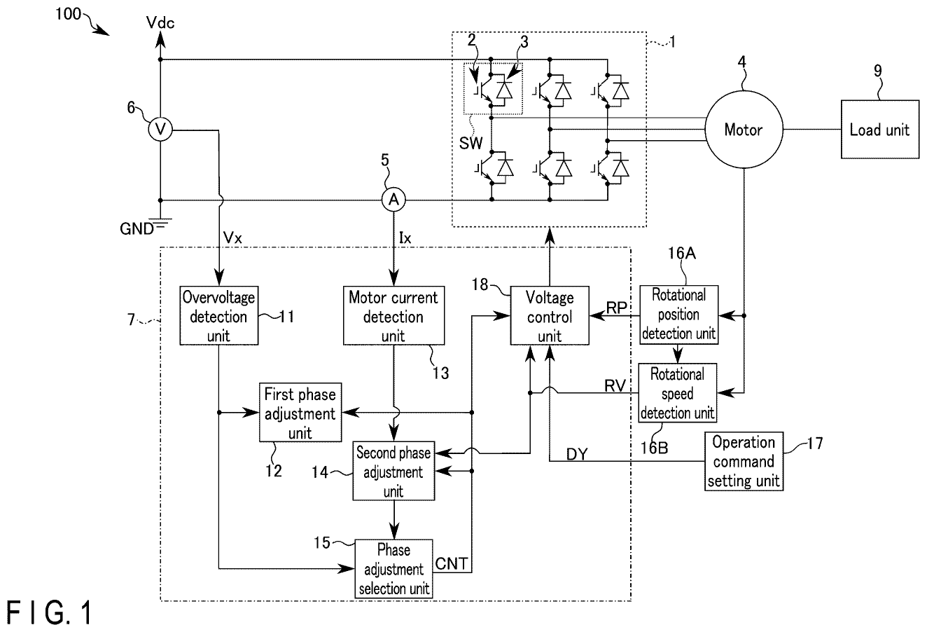

A motor drive device and a method of controlling the motor drive device according to an embodiment will be described with reference to FIG. 1 to FIG. 16. In the following description, elements having the same functions and configuration are given the same reference numerals. Furthermore, in each of the following embodiments, in a case where constituent elements (e.g., a circuit, wiring, various voltages and signals, etc.) assigned reference signs with numbers/letters for distinction at their ends do not need to be distinguished from each other, descriptions (reference signs) with the numbers/letters omitted from their ends are used.

### EMBODIMENTS

### (1) First Embodiment

A motor drive device and a control method therefor according to a first embodiment will be described with reference to FIGS. 1 to 11.

### (a) Configuration

FIG. 1 is a circuit and functional block diagram of the motor drive device according to the first embodiment.

As shown in FIG. 1, a motor drive device 100 according to the present embodiment includes an inverter circuit 1, a three-phase synchronous motor (electric motor) 4, a current detection unit 5, a voltage detection unit 6, an overvoltage detection unit 11, a first phase adjustment unit 12, a motor current detection unit 13, a second phase adjustment unit 14, a phase adjustment selection unit 15, a rotational position detection unit 16A, a rotational speed detection unit 16B, an operation command setting unit 17, and a voltage control unit 18. It should be noted that a term “unit” can be replaced with a term “circuit (or circuitry)” or term “device”.

The inverter circuit 1 is a power conversion device including a plurality of switching elements SW. Each of the switching elements SW is composed of an insulated gate bipolar transistor (IGBTs) 2 and a freewheel diode 3. The inverter circuit 1 is composed of, for example, a two-level circuit in which IGBTs 2 and the freewheel diodes 3 connected in anti-parallel to the IGBTs 2 are bridge-connected at three phases. However, the inverter circuit 1 may be replaced with a multilevel circuit having three or more levels. The switching element SW may be composed of a field effect transistor such as a MOSFET.

The inverter circuit 1 is connected to a DC power source Vdc. The inverter circuit 1 converts a voltage according to the DC power source Vdc into AC power (AC voltage) of a given voltage value and frequency by controlling on/off commands for the plurality of IGBTs 2. The inverter circuit 1 supplies the AC power after the conversion to the motor 4. As a result, a drive voltage for the motor 4 is applied from the inverter circuit 1 to the motor 4.

The motor 4 is a device including a three-phase synchronous motor. The motor 4 drives in response to the supplied AC power (drive voltage). A drive force of the motor 4 is applied to the load unit 9 connected to the motor 4. The load unit 9 is, for example, a fan having large inertia. For example, the motor drive device 100 according to the present embodiment is a drive device for a fan motor.

The rotational position detection unit 16A is means for detecting a rotational position of the motor 4. The rotational position detection unit 16A may be configured with a mechanism based on a detection method using hardware sensors such as a position sensor and a Hall sensor, or a position sensorless detection method in which a rotational position is estimated using mathematical calculation from a motor current, etc. For example, the rotational position detection unit 16A detects a signal synchronized with a rotational position of the motor 4. The rotational position of the motor 4 is correlated with a phase of a voltage (inverter voltage) supplied from the inverter circuit 1.

The rotational speed detection unit 16B is means for detecting a rotational speed of the motor 4. For example, the rotational speed detection unit 16B calculates a rotational speed RV of the motor 4 on the basis of information on a rotational position of the motor from the rotational position detection unit 16A and a signal detected according to a rotational speed of the motor 4. For example, the rotational speed detection unit 16B calculates the rotational speed RV from information on a position of a rotor of the motor 4. The rotational speed detection unit 16B is capable of supplying the obtained rotational speed RV to the second phase adjustment unit 14 which will be described later.

The operation command setting unit 17 is a higher-level device that supplies an operation signal given from an outside of a motor system. Herein, the operation command setting unit 17 is composed of means for providing a voltage amplitude (duty) DY from an outside to the voltage control unit 18 which will be described later, and for discretionarily controlling a rotational speed of the motor 4.

The voltage control unit 18 receives a signal according to the rotational position RP detected by the rotational position detection unit 16A, a signal according to the rotational speed RV detected by the rotational speed detection unit 16B, a signal according to the voltage amplitude DY from the operation command setting unit 17, and a signal according to a phase adjustment amount CNT from the phase adjustment units 12 and 14 described later. The voltage control unit 18 generates on/off commands (e.g., PWM signals) for the plurality of IGBTs 2 on the basis of the rotational position RP, the rotational speed RV, the voltage amplitude DY, and the phase adjustment amount CNT described later.

The voltage detection unit 6 and the overvoltage detection unit 11 are mechanisms (devices) that detect overvoltage of a DC voltage (also called an “inverter DC voltage”) Vx of the inverter circuit 1. The voltage detection unit 6 detects the DC voltage Vx supplied to a DC input side of the inverter circuit 1. The overvoltage detection unit 11 receives a signal according to the DC voltage Vx detected by the voltage detection unit 6. In a case where the DC voltage Vx exceeds a preset overvoltage detection threshold (first threshold), the overvoltage detection unit 11 recognizes, as overvoltage, the DC voltage Vx that has exceeded the detection threshold. A function of the overvoltage detection unit 11 may be implemented by a comparator serving as an analog circuit. Alternatively, the function of the overvoltage detection unit 11 may be implemented by capturing DC voltage information from an analog to digital converter (ADC) into a processor and comparing the DC voltage information with a detection threshold value within the processor.

The first phase adjustment unit 12 is a control unit for suppressing overvoltage in the inverter circuit 1. The first phase adjustment unit 12 determines the amount of adjustment of a phase of the inverter circuit 1 on the basis of an overvoltage determination result of the overvoltage detection unit 11. The first phase adjustment unit 12 receives an output signal of the overvoltage detection unit 11. The first phase adjustment unit 12 receives various parameters for a previous control from the phase adjustment selection unit 15. For example, the first phase adjustment unit 12 receives the previous phase adjustment amount CNT (and the previous phase advancing control amount) of the drive voltage of the motor 4 output from the inverter circuit 1. For example, in a case where overvoltage is detected, the first phase adjustment unit 12 outputs a value obtained by incrementing the previous phase adjustment amount CNT generated by the phase adjustment selection unit 15 (a value obtained by adding 1).

The current detection unit 5 and the motor current detection unit 13 are mechanisms (devices) that detect the DC current Ix of the inverter circuit 1. The current detection unit 5 detects the DC current Ix flowing through the inverter circuit 1. The motor current detection unit 13 receives a signal according to the DC current Ix detected by the current detection unit 5. The motor current detection unit 13 detects a motor current of at least one phase of the motor 4 on the basis of the DC current Ix. The current detection unit 5 and the motor current detection unit 13 each have a circuit function of detecting a three-phase current of the motor 4 on the basis of conduction states of the plurality of IGBTs 2 that configure the inverter circuit 1, using information on the DC current Ix. The current detection unit 5 and the motor current detection unit 13 may be replaced with a shunt resistor or a current sensor as long as the motor current can be detected. Furthermore, the current detection unit 5 and the motor current detection unit 13 may be configured by providing the detection means described above on motor three-phase wiring in the inverter circuit 1, rather than on the DC part of the inverter circuit 1.

The second phase adjustment unit 14 is a control unit for controlling highly efficient operation of the motor 4. The second phase adjustment unit 14 receives an output signal from the motor current detection unit 13. The second phase adjustment unit 14 receives various parameters for the previous control from the phase adjustment selection unit 15. For example, the second phase adjustment unit 14 receives the previous phase adjustment amount CNT (and the previous phase advancing control amount) of the drive voltage supplied to the inverter circuit 1. The second phase adjustment unit 14 outputs a value obtained by incrementing or decrementing (subtracting 1 from) the previous phase adjustment amount CNT generated by the phase adjustment selection unit 15 so as to reduce the motor current.

The phase adjustment selection unit 15 receives an output signal of the first phase adjustment unit 12 and an output signal of the second phase adjustment unit 14. The phase adjustment selection unit 15 receives an overvoltage detection result of the overvoltage detection unit 11. The phase adjustment selection unit 15 selects one of the calculation results (output signals) by the first phase adjustment unit 12 and the second phase adjustment unit 14. The phase adjustment selection unit 15 outputs a signal according to a selection result to the voltage control unit 18. Since a control of the motor 4 with high efficiency is required in normal operation, the phase adjustment selection unit 15 selects output by the second phase adjustment unit 14. In a case where overvoltage is detected and the motor system is to be immediately protected, the phase adjustment selection unit 15 selects an output by the first phase adjustment unit 12. The phase adjustment selection unit 15 feeds back the selected previous phase adjustment amount CNT to the phase adjustment units 12 and 14.

Each of the units 5, 6, 11, 12, 13, 14, 15, 16A, 16B, 17, and 18 may be composed of hardware such as a circuit (circuitry). For example, the overvoltage detection unit 11, the first phase adjustment unit 12, the motor current detection unit 13, the second phase adjustment unit 14, the phase adjustment selection unit 15, and the voltage control unit 18 may be functional blocks each composed of a microcomputer (or processor) 7. That is, the microcomputer 7 realizes the functions of the overvoltage detection unit 11, the first phase adjustment unit 12, the motor current detection unit 13, the second phase adjustment unit 14, the phase adjustment selection unit 15, and the voltage control unit 18. Meanwhile, the rotational position detection unit 16A and the rotational speed detection unit 16B may be functional blocks each composed of the microcomputer 7.

In the motor drive device 100 according to the present embodiment, the voltage control unit 18 controls the operation of the inverter circuit 1 on the basis of the phase adjustment amount CNT selected by the phase adjustment selection unit 15. The motor 4 is driven with the AC power generated by the inverter circuit 1.

### (b) Principle

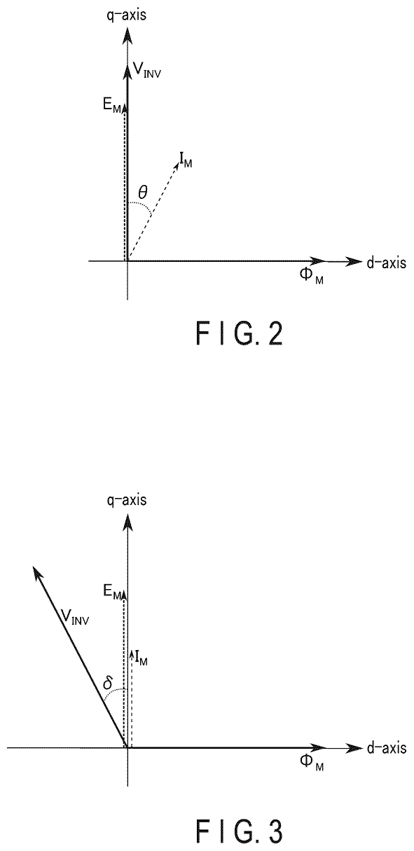

The control principle of the motor drive device 100 according to the first embodiment will be described with reference to FIG. 2 to FIG. 8.

FIG. 2 and FIG. 3 are each a vector diagram relating to the motor drive device 100 according to the first embodiment. The vector diagrams in FIG. 2 and FIG. 3 each show a rotating coordinate system in which a magnetic flux direction of the motor rotor is set to a d-axis and a direction perpendicular to the d-axis is set to a q-axis. FIG. 2 and FIG. 3 each show an inverter voltage vector V_{INV}, the back EMF (electromotive force) vector E_{M} in the motor induced voltage, a motor current vector I_{M}, and a motor magnetic flux vector Φ_{M}.

In FIG. 2, the inverter voltage vector V_{INV} is applied in the same phase as that of the back EMF vector E_{M} without phase adjustment. The back EMF vector E_{M} and the inverter voltage vector V_{INV} are along the q-axis. In such a case, the motor current vector I_{M} is delayed by a phase difference θ with respect to the back EMF vector E_{M} (q-axis).

In FIG. 3, the inverter voltage vector V_{INV} is advanced by the phase δ with respect to the back EMF vector E_{M}, as compared to FIG. 2. By this, in the vector diagram FIG. 3, the phase of the motor current vector I_{M} is matched with the phase of the back EMF vector E_{M}.

Herein, the torque T_{M} in a surface magnet motor in which a permanent magnet is attached to the surface of the rotor can be expressed as formula (f1) using the number of motor pole pairs P. Meanwhile, the motor magnetic flux Φ_{M} and the motor current I_{M} are shown as scalar quantities.

$${T}_{M} = P {Φ}_{M} {I}_{M} cos θ \qquad ( f1 )$$

In the right side of the formula (f1), the number of motor pole pairs P and the motor magnetic flux Φ_{M} are constants specific to the motor. Furthermore, when it is assumed that the motor current I_{M} is also constant, the torque T_{M} can be maximized by maximizing a value of cos θ. The maximum value of cos θ is equal to “1” where θ=0 [rad].

That is, in the surface magnet motor, the maximum torque is obtained in a case where the conditions in the vector diagram in FIG. 3 are satisfied. In a case where a given torque T_{M} is desired to be obtained, the motor current I_{M} is minimized by setting θ=0 [rad], so that the motor efficiency can be increased.

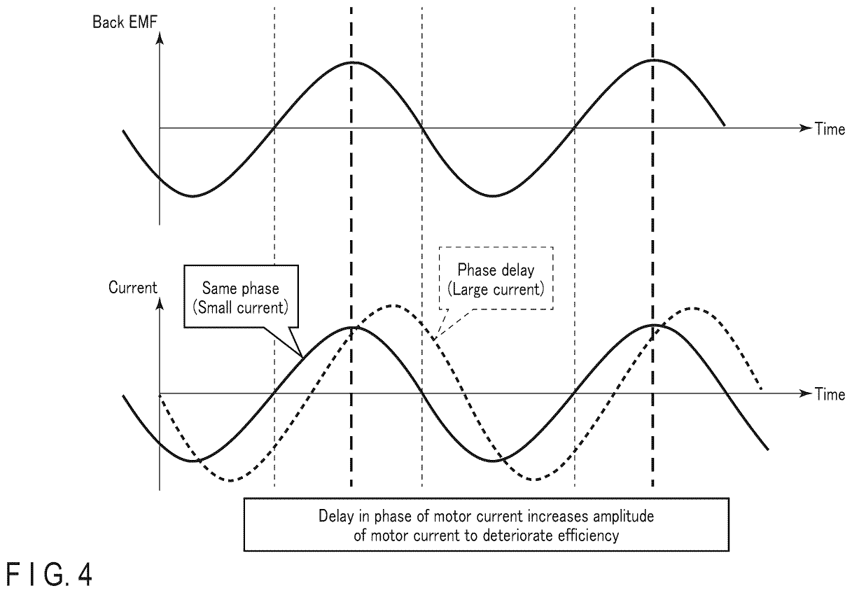

FIG. 4 is a diagram showing the relationship between the phase of the back EMF (electromotive force) and the phase of the motor current relating to the motor drive device 100 according to the present embodiment. FIG. 4 shows the phase relationship between the back EMF and the motor current in rotation.

The magnitude of the back EMF changes depending on the motor's rotational position.

As shown in FIG. 4, the surface magnet motor achieves the maximum efficiency by matching the phase of the back EMF with the phase of the motor current, as shown by the solid line current waveform in FIG. 4. However, if the phase of the motor current is delayed, as shown by the dashed current waveform in FIG. 4, the efficiency of the motor deteriorates and the motor current increases. Similarly, if the phase of the motor current is advanced, the efficiency of the motor deteriorates.

An advanced/delayed in the phase of the motor current can be adjusted depending on the phase of the inverter voltage. Therefore, simple motor control with excellent response can be established by advancing the phase of the inverter voltage if the phase of the motor current is delayed with respect to the phase of the reference motor induced voltage, and by delaying the phase of the inverter voltage if the phase of the motor current is advanced.

On the other hand, the torque T_{M} in an embedded magnet motor in which a permanent magnet is embedded inside the rotor is expressed by formula (f2) below.

$${T}_{M} = P \{ {Φ}_{M} + ( {L}_{q} - {L}_{d} ) {I}_{M} sin θ \} {I}_{M} cos θ \qquad ( f2 )$$

In the formula (f2), L_{d} represents an inductance of a d-axis component, and L_{q} represents an inductance of a q-axis component. Since the embedded magnet motor has saliency, the relationship of L_{q}>L_{d} is established. Meanwhile, in the case of the surface magnet motor, L_{q}=L_{d} is established because of lack of saliency, the term including “L_{q}-L_{d}” in the formula (f2) turns out to be 0 (zero). Therefore, the formula (f2) from which the term to be equal to 0 is deleted becomes equivalent to the formula (f1).

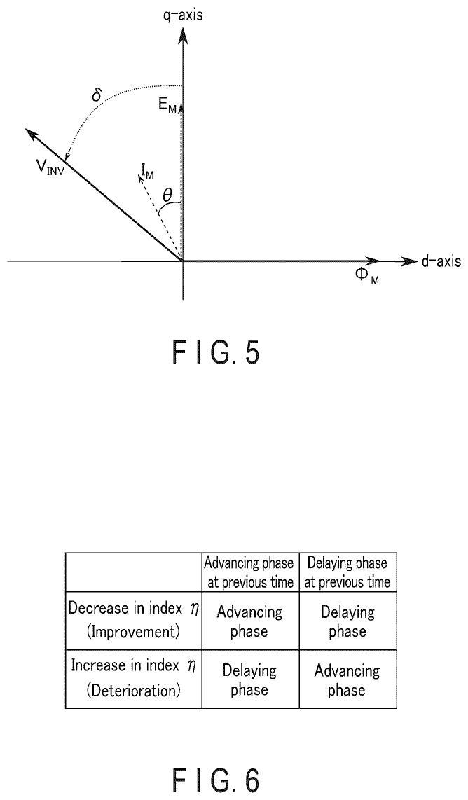

FIG. 5 is a vector diagram relating to the motor drive device 100 according to the present embodiment.

The vector diagram shown in FIG. 5 shows the inverter voltage vector V_{INV}, the back EMF vector E_{M}, the motor current vector I_{M}, and the motor magnetic flux vector Φ_{M}. In FIG. 5, the phase of the inverter voltage vector V_{INV} is further advanced, as compared to FIG. 2 and FIG. 3, so that the phase of the motor current vector I_{M} is advanced by phase θ from the phase of the back EMF vector E_{M}.

The maximum torque per ampere (MTPA) control is known as a high-efficiency control method for embedded magnet motors, and the stable phase (for example, optimal phase) θ of the motor current I_{M} is expressed by formula (f3) where Φ_{M} represents the motor magnetic flux.

$$sin θ = \frac{- {Φ}_{M} + \sqrt{{Φ}_{M}^{2} + 8 {( {L}_{q} - {L}_{d} )}^{2} {I}_{M}^{2}}}{4 ( {L}_{q} - {L}_{d} ) {I}_{M}} \qquad ( f3 )$$

Since an outcome of the formula (f3) is positive, the optimal phase θ of the motor current I_{M} of the embedded magnet motor is advanced from the phase of the back EMF E_{M}, as shown in FIG. 5.

In addition, in the formula (f3), the phase θ depends on the motor current I_{M}. Therefore, the optimal phase θ of the motor current I_{M} of the embedded magnet motor changes depending on the load and operating state. The aforementioned control in which the phase of the back EMF E_{M} is matched with the phase of the motor current I_{M} is a control aiming for θ=0. Thus, an embedded magnet motor whose optimal phase is θ≠0 cannot obtain the maximum efficiency by the control in which the phase of the back EMF E_{M} is matched with the phase of the motor current I_{M}.

On the other hand, the equation to determine the optimal phase θ of the motor current I_{M} in the embedded magnet motor shown as the equation (f3) includes a square root and division. This is not a problem if the motor drive device is a central processing unit (CPU) with high processing power. However, in a case of an attempt to configure the motor drive device using a cheap and small integrated circuit (IC) with inferior processing power, it is difficult to implement the formula (f3).

For this reason, a method for obtaining the optimal phase θ of the motor current I_{M} of an embedded magnet motor using an IC with poor processing power is discussed. Based on the principle of MTPA control, it suffices that means for maximizing the torque T_{M} with respect to the motor current I_{M} or for minimizing the motor current I_{M} with respect to the torque T_{M} are considered. Therefore, the ratio of the torque T_{M} to the motor current I_{M} (I_{M}/T_{M}) is considered as an index.

The index I_{M}/T_{M} includes the torque T_{M}; however, information such as the motor magnetic flux and inductance is set as indicated in the formula (f1) and the formula (f2). The motor control using an IC with inferior processing power has difficulties in handling a large number of parameters. Therefore, attention is focused on the motor's motion equation indicated in formula (f4). In the formula (f4), M represents the motor's inertia constant, w represents the angular velocity, T_{M} represents the motor output torque, T_{L} represents the load torque, and ΔT represents the deviation between the motor output torque and the load torque.

$$M \frac{\partial ω}{\partial t} = {T}_{M} - {T}_{L} ( = Δ T ) \qquad ( f4 )$$

At this time, transformation of the formula (4) from the viewpoint of change from a given time and speed derives formula (f5) below. Note that Δω represents a speed deviation, and Tₛ represents a control cycle.

$$Δ ω = \frac{{T}_{s}}{M} \cdot Δ T \qquad ( f5 )$$

In the formula (f5), Tₛ and M are constants. Therefore, the speed deviation Δω and the torque deviation ΔT are proportional to each other. Accordingly, in the index I_{M}/T_{M}, by replacing the torque T_{M} with the speed Φ in light of the relationship in the formula (f5), an index η in formula (f6) below can be handled as equivalent to the ratio of the motor current I_{M} to the torque T_{M}.

$$η = \frac{{I}_{M}}{ω} \qquad ( f6 )$$

Based on the index η obtained from the formula (6), the voltage phase is adjusted so as to reduce the index η. This enables the optimal phase of the motor current to be derived.

The formula (6) includes division; however, control processing for obtaining the speed Φ has a count value N for measuring an elapsed time of a given period, so that the index η can be expressed by multiplication as in formula (f7) below. Meanwhile, N is a positive integer and corresponds to the reciprocal of the speed.

$$η = {I}_{M} \times N \qquad ( f7 )$$

A method of adjusting a phase of a motor current using the index η determines a control direction in the next calculation cycle according to a change in index η after the phase of the motor current (or inverter voltage) is advanced or delayed, as shown in FIG. 6. In FIG. 6, the advancing phase indicates adjusting the voltage phase in the positive direction, and the delaying phase indicates adjusting the voltage phase in the negative direction.

In FIG. 6, a control for the advancing phase (advancing angle) or the delaying phase (delaying angle) is performed for the phase adjustment of the motor current, as follows.

If the previous control is for the advancing phase and the index η is decreased, the control for the advancing phase is performed. If the previous control is for the advancing phase and the index η is increased, the control for the delaying phase is performed. If the previous control is for the delaying phase and the index η is decreased, the control for the delaying phase is performed. If the previous control is for the delaying phase and the index η is increased, the control for the advancing phase is performed. Meanwhile, a decrease in index η means an improvement in efficiency, and an increase in index η means a deterioration in efficiency.

In addition, a state in which a change from the advancing phase to the delaying phase or a change from the delaying phase to the advancing phase is repeated in a short period of time using the method described above indicates that the phase of motor current is in the vicinity of the optimum value. Herein, the number of changes from the advancing phase to the delaying phase and from the delaying phase to the advancing phase is defined as the number of inflection points N_{infle}. By setting a given upper limit value for this number of inflection points N_{infle}, phase advancing control (phase control) is converged (ended) after a certain number of repeated trials. As described above, it takes time for the control to be converged through the repeated trials. Thus, the responsiveness of the efficiency-based control is inferior to the control based on the phase of the back EMF and the phase of the motor current described above. Meanwhile, in a case where a certain number of advancing phases or delaying phases occur consecutively, the number of inflection points N_{infle} is reset to 0 (zero), so that inadvertent convergence to a phase other than the optimal phase of the motor current is avoided.

Regenerative braking is generated in accordance with the control of the motor by the motor drive device 100.

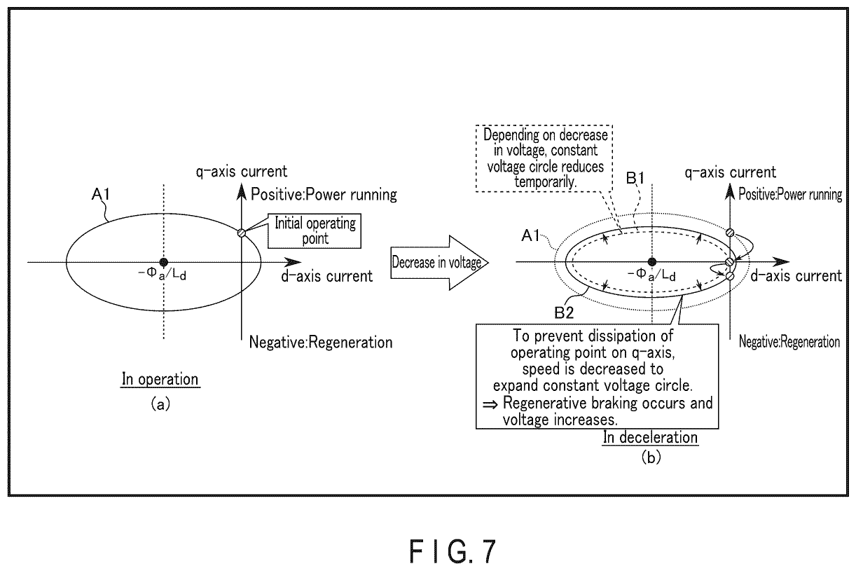

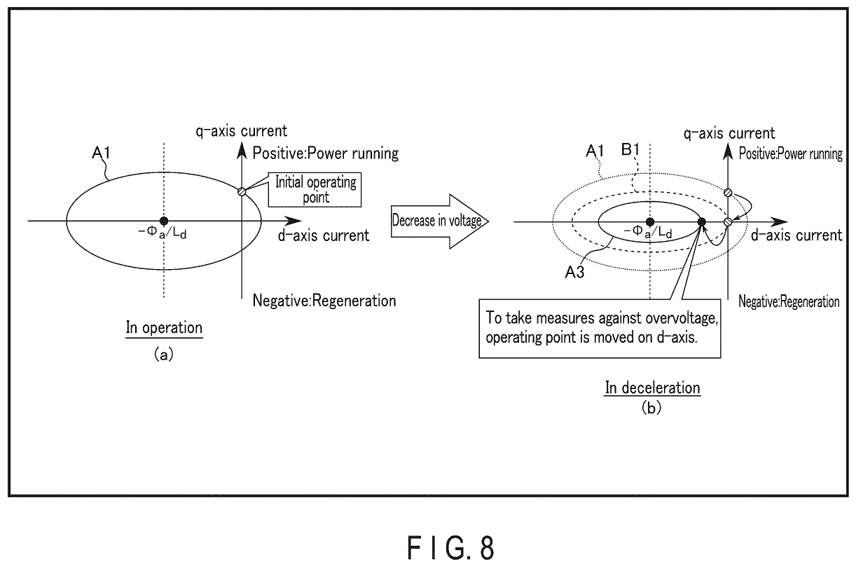

FIG. 7 and FIG. 8 are each a schematic diagram relating to the influence of regenerative braking in the motor drive device 100 according to the present embodiment. FIG. 7 and FIG. 8 each show a relationship between the trajectory of the current operating point and the constant voltage circle in operation and in deceleration. Meanwhile, it is assumed that control is applied to match the phase of the back EMF with the phase of the motor current in the aforementioned surface permanent magnet motor, and the current operating point moves only on the q-axis current axis.

(a) of FIG. 7 shows, as the initial state, the current operating point (initial position) and the constant voltage circle in operation. Meanwhile, the size of the constant voltage circle is proportional to the voltage/rotational speed. (b) of FIG. 7 shows the change at a time when the inverter voltage is decreased to decelerate or stop the motor.

As shown in FIG. 7, in a case where the motor drives the load unit having inertia such as a fan, the rotational speed of the motor is not decreased immediately even when the inverter voltage is decreased. Therefore, a constant voltage circle A1 becomes smaller. In a case where the inverter voltage is continuously decreased, there comes a moment when the constant voltage circle and the q-axis intersect at only one point, the origin. However, due to the constraints of the high-efficiency control described above, a constant voltage circle B1 cannot be made any smaller. However, since the inverter voltage is continuously decreased, it becomes necessary to maintain or expand the size of the constant voltage circle by decreasing the rotational speed. Decreasing the rotational speed requires braking, and regenerative braking is generated by shifting the current operating point to the negative side of the q-axis current. At this time, if there is no regenerative load, the voltage of the inverter circuit rises, as shown by a constant voltage circle B2, thereby overvoltage occurs.

(a) of FIG. 8 shows the initial state in operation, as with (a) of FIG. 7. (b) of FIG. 8 is partially the same as (b) of FIG. 7. As described above, in a case of driving a load having inertia, such as a fan, the rotational speed of the motor is not decreased immediately after the inverter voltage is decreased, so that the constant voltage circle becomes smaller.

In a case where the inverter voltage is continuously decreased, there comes a moment when the constant voltage circle B1 and the q-axis intersect at only one point, the origin. However, by the current operating point in this state being moved in the negative direction of the d-axis, the constant voltage circle A3 is allowed to become even smaller. At this time, the current operating point does not move to the negative side of the q-axis, so that regenerative braking does not occur. Therefore, no overvoltage occurs. Meanwhile, the movement of the current operating point on the q-axis and d-axis is realized by the phase θ of the motor current being moved by adjusting the phase δ of the inverter voltage, as shown in FIGS. 1, 2, and 5.

Based on the above principles, the motor drive device 100 according to the present embodiment can achieve highly efficient driving of the motor while suppressing overvoltage.

### (c) Operation

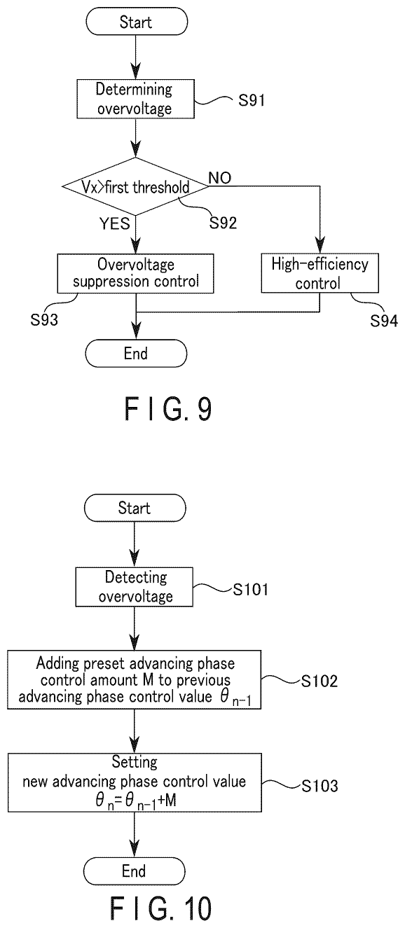

A control method for the motor drive device 100 according to the present embodiment will be described with reference to FIG. 9 to FIG. 11.

FIG. 9 is a flowchart of the phase advancing control (phase control) relating to the control method for the motor drive device 100 according to the present embodiment. The phase advancing control refers to a control function for adjusting the phase δ of the inverter voltage shown in FIGS. 1, 2, and 5. Advancing the phase of voltage (or current) is expressed as “advancing phase”, and delaying the phase of voltage (or current) is expressed as “delaying phase”.

The phase advancing control shown in the flowchart of FIG. 9 is composed of various types of processing including steps S91, S92, S93, and S94.

### <S91>

In step S91, the motor drive device 100 executes overvoltage determination. The motor drive device 100 detects the current inverter DC voltage Vx through the operation of the voltage detection unit 6 and the overvoltage detection unit 11 in FIG. 1.

### <S92>

In step S92, the motor drive device 100 determines whether or not the current (present) DC voltage Vx of the inverter circuit 1 exceeds a preset overvoltage detection threshold (first threshold) in relation to the operation of the voltage detection unit 6 and the overvoltage detection unit 11.

### <S93>

In step S93, if the magnitude of the DC voltage Vx exceeds the detection threshold (YES in S92), the motor drive device 100 executes overvoltage suppression control. This suppresses overvoltage generated in the inverter circuit 1.

### <S94>

In step S94, in a case where the magnitude of the DC voltage Vx does not exceed the detection threshold (NO in S92), the motor drive device 100 executes the high-efficiency control. This drives the motor 4 with high efficiency.

While the motor 4 is in operation, the motor drive device 100 repeatedly executes the processing in steps S91, S92, S93, and S94.

The overvoltage suppression control in step S93 is control processing of the first phase adjustment unit 12 in FIG. 1. The overvoltage suppression control is a function of controlling the current operating point in the negative direction of the d-axis in order to take measures against the overvoltage shown in FIG. 8, and forcibly advances the phase of the inverter voltage.

FIG. 10 is a flowchart of the overvoltage suppression control relating to the control method for the motor drive device 100 according to the first embodiment. The flowchart in FIG. 10 shows a more specific example of the overvoltage suppression control (S93) in FIG. 9.

### <S101>

In step S101, the motor drive device 100 detects overvoltage using the voltage detection unit 6 and the overvoltage detection unit 11.

### <S102>

In step S102, the motor drive device 100 adds a preset phase advancing control amount M to the phase advancing control value θₙ₋₁ obtained through the overvoltage suppression control (S93) or the high-efficiency control (S94) in the previous processing by the first phase adjustment unit 12.

### <S103>

In step S103, the motor drive device 100 sets, by the first phase adjustment unit 12, an addition result M (θₙ₋₁+M) of the previous phase advancing control value θₙ₋₁ and the phase advancing control amount M, as a new phase advancing control value (current phase advancing control value) θₙ.

The motor drive device 100 outputs the set phase advancing control value θₙ=θₙ₋₁+M from the first phase adjustment unit 12 to the phase adjustment selection unit 15. In a case where overvoltage is detected, the phase adjustment selection unit 15 outputs, as the phase adjustment amount CNT, the phase advancing control value θₙ=θₙ₋₁+M to the voltage control unit 18.

Through the processing in steps S101, S102, and S103, the overvoltage suppression control is executed.

The high efficiency control in step S94 is control processing of the second phase adjustment unit 14 in FIG. 1. Examples of the high efficiency control include the aforementioned control for matching the phase of the back EMF with the phase of the motor current in the surface permanent magnet motor. To enhance the efficiency of the operation of the motor 4, in accordance with the operating state of the motor 4, the second phase adjustment unit 14 advances the phase by adding the preset phase advancing control amount M to the previous phase advancing control value θₙ₋₁, or delays the phase by subtracting the phase advancing control amount M from the previous phase advancing control value θₙ₋₁.

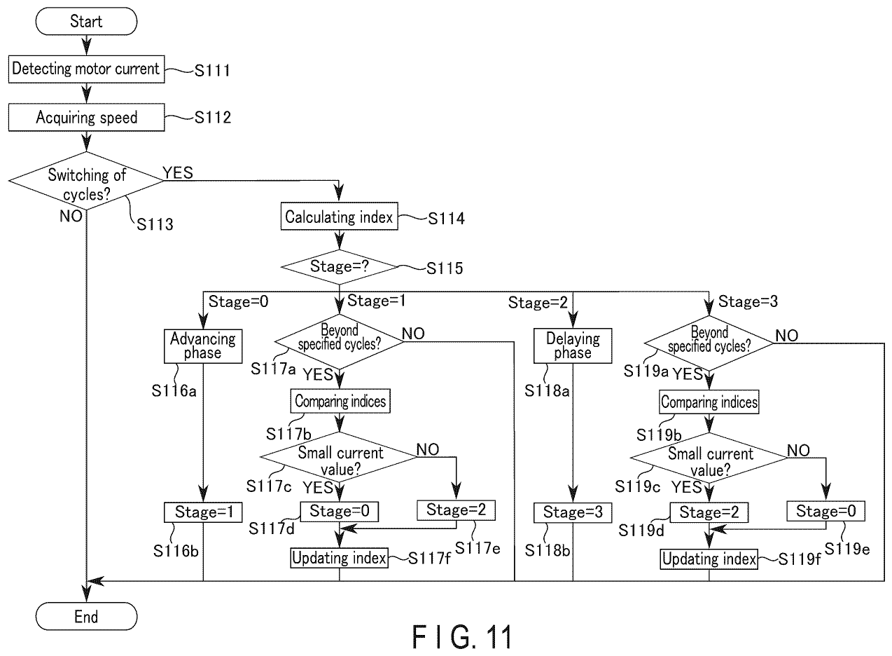

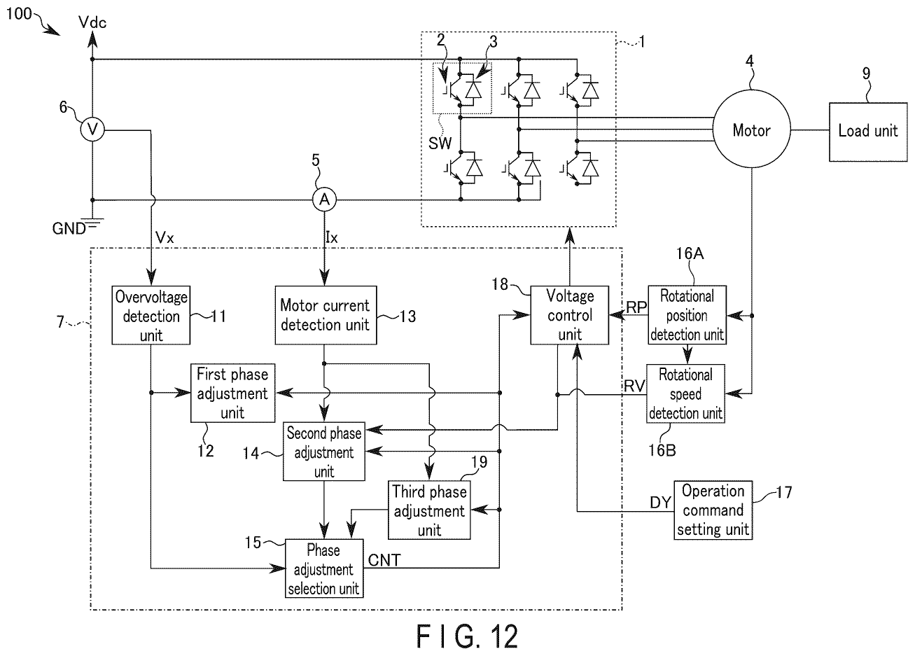

FIG. 11 is a flowchart of the high-efficiency control relating to the control method for the motor drive device 100 according to the first embodiment. The flowchart in FIG. 11 shows a more specific example of the high-efficiency control (S94) in FIG. 9.

The high-efficiency control shown in the flowchart of FIG. 11 is composed of various types of processing in steps S111, S112, S113, S114, S115, S116a, S116b, S117a, S117b, S117c, S117d, S117e, S117f, S118a, S118b, S119a, S119b, S119c, S119d, S119e, and S119f.

### <S111>

In step S111, the motor drive device 100 acquires a current peak value of the motor current. For example, the motor drive device 100 acquires the current peak value for each cycle of the motor current through the operation of the current detection unit 5 and the motor current detection unit 13.

### <S112>

In step S112, the motor drive device 100 acquires the rotational speed of the motor 4 using the rotational speed detection unit 16B.

### <S113>

In step S113, the motor drive device 100 executes a period switching determination on the basis of the current peak value and the rotational speed. Based on the determination results of the current peak value and the rotational speed, the motor drive device 100 detects the completion of one cycle (period) of operation of the motor 4. In a case where switching of cycles has not occurred (NO in S113), the motor drive device 100 terminates the process.

In response to detection of the completion of one cycle of the operation (YES in S113), the motor drive device 100 performs the subsequent processing once per cycle using the second phase adjustment unit 14.

### <S114>

In a case where switching of cycles has occurred (YES in S113), in step S114, the motor drive device 100 executes an index calculation using the second phase adjustment unit 14. The motor drive device 100 calculates (accumulates) an index ηₙ using a motor current peak value Iₚ and a speed count value N acquired for each cycle, as in formula (f8) below. Meanwhile, ηₙ₋₁ presents a value of a previous calculation result.

$${η}_{n} = {η}_{n - 1} + {I}_{p} \times N \qquad ( f8 )$$

Regarding the accumulated index ηₙ, after a completion of an index determination (S117b, S119b) which will be described later, a previous index value ηₙ₋₁ is updated (ηₙ₋₁=ηₙ), and then the current index value ηₙ is initialized (ηₙ=0).

### <S115>

In step S115, the motor drive device 100 executes a stage determination. The motor drive device 100 executes one of the plurality of branches from processing according to the phase adjustment state (stage value) using the second phase adjustment unit 14.

### <S116a, S116b>

In a case where a stage value is equal to 0, in step S116a, the motor drive device 100 advances the phase by a predetermined amount. In step S116b, the motor drive device 100 sets the stage value to 1.

### <S117a-S117f>

In a case where the stage value is equal to 1, in step S117a, the motor drive device 100 checks whether or not the number of cycles (periods) of the motor 4 has passed a predetermined specified number of cycles. In a case where the cycles of the motor 4 has not passed the specified number of cycles (NO in S117a), the motor drive device 100 does not execute the processing.

In a case where the cycle of the motor 4 has passed the specified number of cycles (YES in S117a), in steps S117b and S117c, the motor drive device 100 executes a comparison of the indices, thereby comparing the current value ηₙ of the index η with the previous value ηₙ₋₁ of the index η. For example, it is determined whether or not the current value ηₙ is smaller than the previous value ηₙ₋₁.

In a case where ηₙ<ηₙ₋₁ is true (YES in S117c), then in step S117d, the motor drive device 100 sets the stage value to 0.

In a case where ηₙ<ηₙ₋₁ is not true (NO in S117c), then in step S117e, the motor drive device 100 sets the stage value to 2.

In step S117f, the motor drive device 100 updates the value of index η to the current value ηₙ.

### <S118a, S118b>

In a case where the stage value is equal to 2, in step S118a, the motor drive device 100 delays the phase by a predetermined amount. In step S118b, the motor drive device 100 sets the stage value to 3.

### <S119a-S119f>

In a case where the stage value is equal to 3, in step S119a, the motor drive device 100 checks whether or not the number of cycles of the motor 4 has passed a predetermined specified number of cycles. In a case where the number of cycles of the motor 4 has not passed the specified number of cycles (NO in S119a), the motor drive device 100 does not execute the processing.

In a case where the number of cycles of the motor 4 has passed the specified number of cycles (YES in S119a), in steps S119b and S119c, the motor drive device 100 executes a comparison of the indices, thereby determining whether or not the current value ηₙ of the index is smaller than the previous value ηₙ₋₁ of the index.

In a case where ηₙ<ηₙ₋₁ is true (YES in S119c), then in step S119d, the motor drive device 100 sets the stage value to 2.

In a case where ηₙ<ηₙ₋₁ is not true (NO in S119c), then in step S119e, the motor drive device 100 sets the stage value to 0.

In step S119f, the motor drive device 100 updates the value of index η to the current value ηₙ.

By setting the stage of the phase advancing control on the basis of a value of the index η in this manner, the motor drive device 100 can control the advancing phase and the delaying phase of a phase of the inverter circuit 1 (or the motor 4) using the second phase adjustment unit 14.

Through the above processing, in controlling a synchronous motor using a permanent magnet, the motor drive device 100 according to the first embodiment can avoid the risk of overvoltage occurring in a case of decelerating or stopping the motor 4 at a time when the load unit 9 with a large inertia, such as a fan, is connected to the motor 4, and can also drive the motor 4 with high efficiency in normal operation.

### (d) Conclusion

Examples of a control method for increasing the efficiency of a motor system include a method of adjusting a phase of a voltage so that a phase of an induced voltage of the motor matches a phase of a current, and a method of adjusting a phase of a voltage so as to decrease a motor current.

A synchronous motor using a permanent magnet generates electricity spontaneously from an induced voltage that occurs with the rotation of the permanent magnet. In a case where the high-efficiency control is applied to the synchronous motor using the permanent magnet, regenerative braking may occur unintentionally depending on the operating state. At the occurrence of regenerative braking without means for consuming the regenerative energy, there has been a risk that a rise in the circuit voltage will lead to overvoltage, thereby causing failures of various devices connected to the motor.

In a case of driving the synchronous motor using the permanent magnet, especially in a case of the motor driving a load with a large inertia, such as a fan, there is a risk of overvoltage occurring due to regenerative braking. If a resistor, etc., which serves as a regenerative load to consume regenerative energy is provided, the risk of an occurrence of overvoltage can be avoided or suppressed. However, with a configuration including a regenerative load, a regenerative load that is not used in normal operation is installed in the motor system, so that the motor system undesirably increases in size.

On the other hand, without a configuration for consuming the generated regenerative energy, the circuit voltage will rise and lead to overvoltage. This causes the need to take measures such as increasing an insulation distance in order to obtain a sufficient withstand voltage margin with respect to various devices including the inverter circuit. In such a case, the various devices increase in size, and costs tend to increase, too.

As a result, the competitiveness of motor system products is lost.

Rather than accepting the risk of overvoltage, the motor drive device 100 according to the present embodiment eliminates the risk of overvoltage by suppressing regenerative energy by devising an innovative motor control method.

As described above, in a case where overvoltage is detected, the motor drive device 100 according to the present embodiment controls a phase of an inverter voltage to suppress overvoltage. In a case where overvoltage is not detected, the motor drive device 100 according to the present embodiment controls the phase of the inverter voltage to drive the motor 4 with high efficiency.

By this, the motor drive device 100 according to the present embodiment can eliminate the risk of overvoltage and achieve highly efficient operation while preventing the device from increasing in size and in cost.

As described above, the motor drive device according to the present embodiment can provide a motor drive device with high performance.

### (2) Second Embodiment

A motor drive device and a control method therefor according to a second embodiment will be described with reference to FIGS. 12 to 16.

### (a) Configuration

An example of a configuration of the motor drive device according to the second embodiment will be described with reference to FIG. 12.

FIG. 12 is a block diagram showing an example of a configuration of the motor drive device 100 according to the present embodiment.

As shown in FIG. 12, a configuration of the motor drive device 100 according to the present embodiment differs from the configuration of the motor drive device 100 according to the first embodiment (see FIG. 1) in terms of further including a third phase adjustment unit 19.

The third phase adjustment unit 19 is a control unit for enhancing the efficiency of operation of the motor 4 using a motor current as input. However, the third phase adjustment unit 19 is configured with a control rule different from that of the second phase adjustment unit 14.

The phase adjustment selection unit 15 selects one of the calculation results of the first phase adjustment unit 12, the second phase adjustment unit 14, and the third phase adjustment unit 19, respectively. The phase adjustment selection unit 15 outputs the selected calculation result as the phase adjustment amount CNT to the voltage control unit 18. The phase adjustment selection unit 15 feeds back the selected previous phase adjustment amount CNT (and the phase advancing control amount) to the first to third phase adjustment units 12, 14, and 19.

In normal operation of the motor, the motor is required to be controlled with high efficiency. Therefore, in normal operation, the phase adjustment selection unit 15 selects either the output of the second phase adjustment unit 14 or the output of the third phase adjustment unit 19. In a case where overvoltage is detected and the motor system needs to be immediately protected, the phase adjustment selection unit 15 selects the output of the first phase adjustment unit 12.

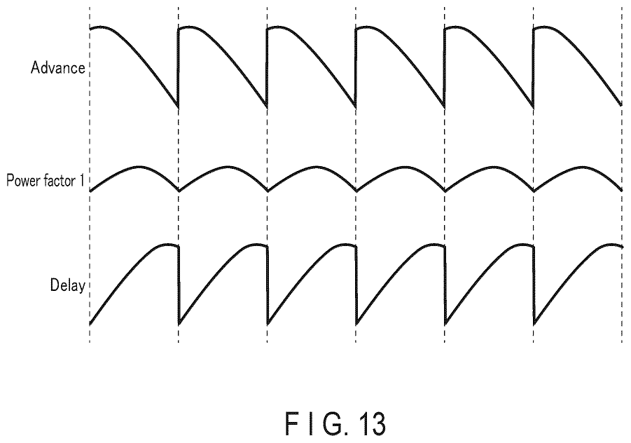

FIG. 13 shows an example of a current waveform obtained by the current detection unit 5 in FIG. 12. Three waveforms are drawn in FIG. 13.

The waveform in the middle is a waveform in a state in which the phase of the inverter voltage matches with the phase of the motor current. In the state in which the phase of the inverter voltage matches with the phase of the motor current, a power factor is equal to 1. In a case of the power factor being equal to 1, a state in which the efficiency is relatively high is achieved.

The upper waveform has a downward sloping shape. The waveform in such a case indicates a state in which the phase of the motor current is advanced as compared to that in the state in which the power factor is equal to 1.

The waveform at the bottom has an upward sloping shape. The waveform in such a case indicates a state in which the phase of the motor current is delayed as compared to that in the state in which the power factor is equal to 1.

As described above, different waveforms of the DC current Ix (for example, the slope of current) are observed depending on the state of the power factor (the rotational position of the motor).

The phase state of the inverter voltage may be observed from the slope of the waveform of the motor current.

The third phase adjustment unit 19 performs control to improve the efficiency of the motor 4 by the phase advancing control based on information obtained from the waveform of the motor current or the DC current Ix.

### (b) Operation

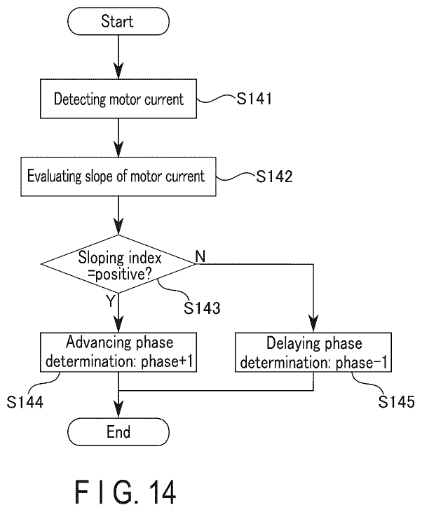

A control method for the motor drive device 100 according to the second embodiment will be described with reference to FIG. 14 to FIG. 16.

FIG. 14 is a flowchart of the high-efficiency control relating to the control method for the motor drive device 100 according to the present embodiment. FIG. 14 shows a flowchart of the control of the third phase adjustment unit 19 shown in FIG. 12.

The control according to the flowchart in FIG. 14 is composed of various types of processing including steps S141, S142, S143, S141, and S145.

### <S141>

In step S141, the motor drive device 100 detects a motor current through processing by the current detection unit 5 and the motor current detection unit 13.

### <S142, S143>

In step S142, the motor drive device 100 executes evaluation of the slope of motor current using the third phase adjustment unit 19. In step S143, the motor drive device 100 determines whether an index of the slope of motor current is positive or not using the third phase adjustment unit 19.

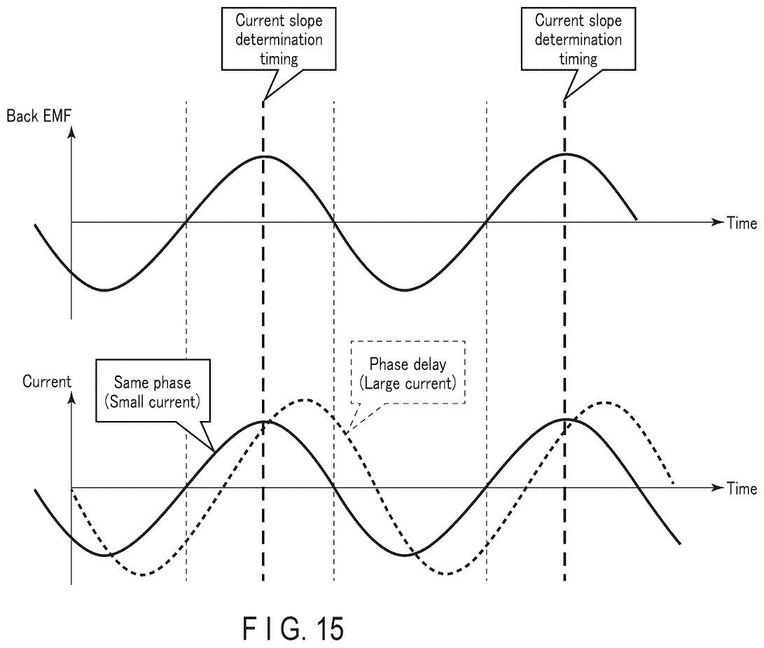

FIG. 15 is a schematic diagram for illustrating an example of a technique for evaluating the slope of the motor current. The magnitude of the back EMF changes depending on the motor's rotational position. As shown in FIG. 15, for example, the motor drive device 100 evaluates the slope of motor current at the timing of the maximum positive amplitude (peak) of the back EMF, using the third phase adjustment unit 19. At a time when the phase of the motor current is delayed, the slope of motor current is positive. At a time when the phase of the motor current is advanced, the slope of motor current is negative. In this way, the phase state of the motor current can be determined from the slope of motor current.

In a case where the exact phase of the back EMF cannot be acquired, the motor drive device 100 determines the slope of motor current on the basis of the upward or downward sloping shape of the waveform of the DC current Ix shown in FIG. 13.

### <S144>

In step S144, in a case where the slope of motor current is positive or the waveform shape of the DC current is an upward sloping shape (YES in step S143), the motor drive device 100 executes the advancing phase determination using the third phase adjustment unit 19. By this, processing of +1 step is performed on the previous phase advancing control value.

### <S145>

In step S145, in a case where the slope of motor current is negative or the waveform shape of the DC current is a downward sloping shape (NO in step S143), the motor drive device 100 executes the delaying phase determination using the third phase adjustment unit 19. By this, processing of −1 step is performed on the previous phase advancing control value.

Through the various types of processing described above, the control by the third phase adjustment unit 19 in the motor drive device 100 according to the present embodiment is completed.

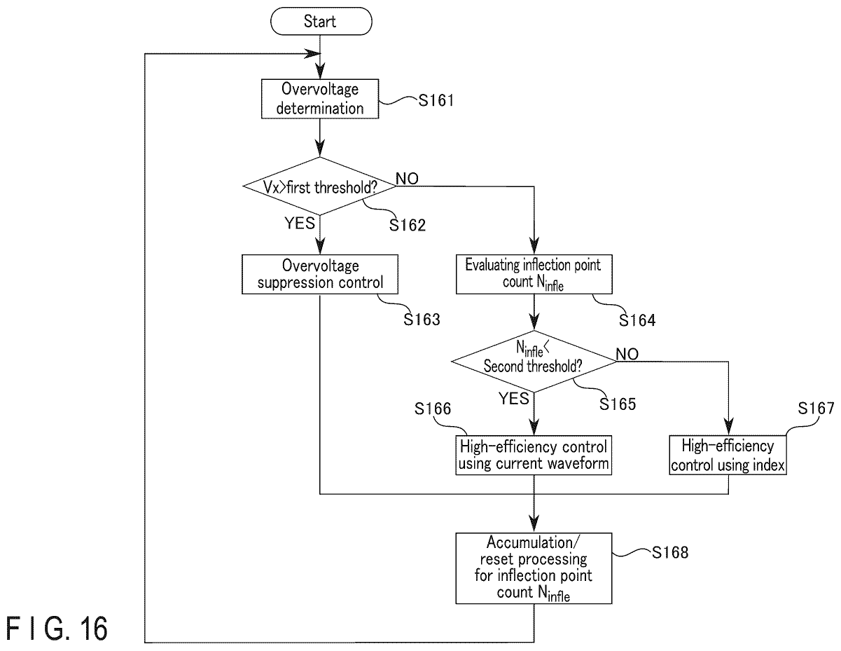

FIG. 16 is a flowchart of the phase advancing control relating to the control method for the motor drive device 100 according to the present embodiment. The flowchart in FIG. 16 shows processing of the phase adjustment selection unit 15. The control according to the flowchart in FIG. 16 is composed of various types of processing including steps S161, S162, S163, S164, S165, S166, S167, and S168.

The flowchart shown in FIG. 16 corresponds to the flowchart relating to the control for the motor drive device 100 according to the first embodiment shown in FIG. 9 with the addition of a condition for switching to the high-efficiency control based on the observation result of the current waveform processed by the third phase adjustment unit 19.

### <S161, S162>

In steps S161 and S162, the motor drive device 100 determines whether or not the current DC voltage Vx of the inverter circuit 1 exceeds a preset overvoltage detection threshold (first threshold) by the operation of the voltage detection unit 6 and the overvoltage detection unit 11, as with the aforementioned steps S91 and S92.

### <S163>

In a case where a value of the DC voltage Vx of the inverter circuit 1 exceeds the detection threshold (YES in S162), the motor drive device 100 executes an overvoltage suppression control on the basis of the processing in FIG. 10 described above, as with step S93 in FIG. 9, using output of the first phase adjustment unit 12 in accordance with the selection by the phase adjustment selection unit 15.

### <S164, S165>

In a case where the value of the DC voltage Vx of the inverter circuit does not exceed a detection threshold (NO in S162), the motor drive device 100 executes processing for the high-efficiency control according to the selection by the phase adjustment selection unit 15.

In step S164, the motor drive device 100 evaluates the number of inflection points N_{infle}. The motor drive device 100 detects the number of changes from the advancing phase to the delaying phase and the number of changes from the delaying phase to the advancing phase.

In step S165, the motor drive device 100 determines whether or not the number of inflection points N_{infle} is smaller than a threshold value (second threshold value). For example, the threshold value for the number of inflection points N_{infle} is set to 1.

### <S166>

In a case where the number of inflection points N_{infle} is smaller than the threshold value (YES in S165), the motor drive device 100 performs the high-efficiency control using the current waveform on the basis of the processing in FIG. 14 described above, using output of the third phase adjustment unit 19 in accordance with the selection by the phase adjustment selection unit 15.

### <S167>

In a case where the number of inflection points N_{infle} is equal to or greater than the threshold value (NO in S165), the motor drive device 100 executes the high-efficiency control using an index on the basis of the processing in FIG. 11 described above, using output of the second phase adjustment unit 14 in accordance with the selection by the phase adjustment selection unit 15.

### <S168>

After the various selected controls, in step S168, the motor drive device 100 executes accumulation processing for the number of inflection points N_{infle} and resets processing for the number of inflection points N_{infle}.

While the motor 4 is in operation, the motor drive device 100 repeatedly executes the processing in steps S161, S162, S163, S164, S165, S166, S167, and S168.

### (c) Conclusion

The motor drive device 100 according to the present embodiment further includes the third phase adjustment unit 19 that performs the high-efficiency control on a basis of the observation result of the current waveform.

In the control method for the motor drive device 100 according to the present embodiment, the added phase advancing control using the waveform shape of the motor current (or the DC current) (see FIG. 14) is superior in terms of responsiveness to the phase advancing control using the index in FIG. 11.

However, the phase advancing control using the waveform shape of the current has difficulties in converging the phase state to the optimal advancing phase (operating point), while phase advancing control using the index is superior in terms of convergence to the optimal advancing phase.

Therefore, the motor drive device 100 according to the present embodiment can achieve both responsiveness and convergence by combining the phase advancing control using the index and the phase advancing control using the current waveform shape.

As described above, in control of a synchronous motor using a permanent magnet, the motor drive device 100 according to the second embodiment can avoid the risk of overvoltage occurring in a case of decelerating or stopping the motor when a load with a large inertia, such as a fan, is connected to the motor, and can also achieve highly efficient control with excellent responsiveness and convergence in normal operation of the motor.

As a result, the motor drive device 100 according to the present embodiment can provide a motor drive device with high performance.

### (3) Others

The motor drive device according to the present embodiment is applicable to home appliances, railroad cars, electric vehicles, power generation systems, etc.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A motor drive device comprising:
a three-phase synchronous motor;
a power conversion device configured to convert a DC voltage into a three-phase AC power of a given voltage and a given frequency through a switching operation of a plurality of semiconductor elements, and supply the three-phase AC power after conversion to the three-phase synchronous motor;
a voltage detection circuit configured to detect a voltage at a DC input side of the power conversion device;
a voltage control circuit configured to provide an on/off command to the plurality of semiconductor elements in order for the power conversion device to apply a drive voltage of a given voltage and a given frequency to the three-phase synchronous motor;
a plurality of phase adjustment circuits each configured to adjust a phase of the drive voltage; and
a phase adjustment selection circuit configured to select one of calculation results of the plurality of phase adjustment circuits and output the selected calculation result to the voltage control circuit,
wherein a first phase adjustment circuit of the plurality of phase adjustment circuits perform control to exert the advancing phase on a phase of the drive voltage in a case where a voltage detection value obtained from the voltage detection circuit exceeds a first threshold value, and
the phase adjustment selection circuit selects an output of the first phase adjustment circuit in a case where the voltage detection value exceeds the first threshold value.

2. The motor drive device according to claim 1, further comprising:
a current detection circuit configured to detect a motor current of at least one phase of the three-phase synchronous motor; and
a rotational speed detection circuit configured to detect a rotational speed of the three-phase synchronous motor,
wherein a second phase adjustment circuit of the plurality of phase adjustment circuits sets, as an index, a ratio of a magnitude of the motor current obtained by the current detection circuit to a magnitude of the rotational speed obtained by the rotational speed detection circuit, and determines, on a basis of a magnitude of the index, the advancing phase or the delaying phase of the phase of the drive voltage, and
the phase adjustment selection circuit selects an output of the second phase adjustment circuit in a case where the voltage detection value is equal to or smaller than the first threshold value.

3. The motor drive device according to claim 2, further comprising a rotational position detection circuit configured to detect a signal synchronized with a rotational position of the three-phase synchronous motor,
wherein a third phase adjustment circuit of the plurality of phase adjustment circuits evaluates a slope of the motor current obtained by the current detection circuit in accordance with the rotational position of the three-phase synchronous motor obtained by the rotational position detection circuit, and determines, on a basis of a result of evaluating the slope, the advancing phase or the delaying phase of the phase of the drive voltage, and
the phase adjustment selection circuit selects one of the output of the second phase adjustment circuit and an output of the third phase adjustment circuit in a case where the voltage detection value is equal to or smaller than the first threshold value.

4. The motor drive device according to claim 3, wherein the third phase adjustment circuit evaluates the slope of the motor current on a basis of a waveform of the motor current.

5. The motor drive device according to claim 3, wherein the third phase adjustment circuit evaluates the slope of the motor current on a basis of an observation result of the motor current at a given timing.

6. The motor drive device according to claim 3, wherein the phase adjustment selection circuit selects the output of the second phase adjustment circuit in a case where a number of changes between the advancing phase and the delaying phase of the phase of the motor current exceeds a second threshold value, and selects the output of the third phase adjustment circuit in a case where the number is equal to or smaller than the second threshold value.

7. A motor drive device comprising:
a three-phase synchronous motor;
a power conversion device configured to convert a DC voltage into a three-phase AC power of a given voltage and a given frequency through a switching operation of a plurality of semiconductor elements, and supply the three-phase AC power after conversion to the three-phase synchronous motor;
a current detection circuit configured to detect a motor current of at least one phase of the three-phase synchronous motor;
a voltage detection circuit configured to detect a voltage at a DC input side of the power conversion device;
a rotational position detection circuit configured to detect a signal synchronized with a rotational position of the three-phase synchronous motor;
a rotational speed detection circuit configured to detect a rotational speed of the three-phase synchronous motor;
a voltage control circuit configured to provide an on/off command to the plurality of semiconductor elements in order for the power conversion device to apply a drive voltage of a given voltage and a given frequency to the three-phase synchronous motor;
a plurality of phase adjustment circuits each configured to adjust a phase of the drive voltage; and
a phase adjustment selection circuit configured to select one of calculation results of the plurality of phase adjustment circuits and output the selected calculation result to the voltage control circuit,
wherein the plurality of phase adjustment circuits include:
a first phase adjustment circuit configured to exert the advancing phase on a phase of the drive voltage in a case where a voltage detection value obtained by the voltage detection circuit exceeds a preset first threshold value;
a second phase adjustment circuit configured to set, as an index, a ratio of a magnitude of the motor current obtained by the current detection circuit to a magnitude of the rotational speed obtained by the rotational speed detection circuit, and determine, on a basis of a magnitude of the index, the advancing phase or the delaying phase of the phase of the drive voltage; and
a third phase adjustment circuit configured to evaluate a slope of the motor current obtained by the current detection circuit in accordance with the rotational position of the three-phase synchronous motor obtained by the rotational position detection circuit, and determine, on a basis of a result of evaluating the slope, the advancing phase or the delaying phase of the phase of the drive voltage, and
the phase adjustment selection circuit selects control of the phase of the drive voltage based on a calculation result of the first phase adjustment circuit in a case where the voltage detection value obtained from the voltage detection circuit exceeds the first threshold value, and selects control of the phase of the drive voltage based on one of calculation results of the second and third phase adjustment circuits in a case where the voltage detection value is equal to or smaller than the first threshold value.

8. The motor drive device according to claim 7, wherein the phase adjustment selection circuit selects the calculation result of the second phase adjustment circuit in a case where a number of changes between the advancing phase and the delaying phase of the phase of the motor current exceeds a second threshold value, and selects the calculation result of the third phase adjustment circuit in a case where the number is equal to or smaller than the second threshold value.

9. The motor drive device according to claim 7, wherein the third phase adjustment circuit evaluates the slope of the motor current on a basis of a waveform of the motor current.

10. The motor drive device according to claim 7, wherein the third phase adjustment circuit evaluates the slope of the motor current on a basis of an observation result of the motor current at a given timing.
